(19) United States
(12) Patent Application Publication
(10) Pub. No.: US 2014/0054309 A1
(43) Pub. Date: Feb. 27, 2014

(54) Product Dispensing System with Dispenser Platform

(71) Applicant: Caleb Loftin, Richmond, VA (US)

(72) Inventor: Caleb Loftin, Richmond, VA (US)

(21) Appl. No.: 13/595,344

(22) Filed: Aug. 27, 2012

(51) Int. Cl. A47F 1/08; B65G 65/23

(52) U.S. Cl. 221/1; 211/59.2

(57) ABSTRACT

A product dispensing system including a frame, a dispenser platform and an attachable cleat, the frame having a front end, a rear end, an upper support deck extending between the front end and the rear end, a lower support deck positioned below the upper support deck, the lower support deck extending between the front end and the rear end and defining a product display area, and a heel proximate the rear end to engage the cleat.

### FIELD

This application relates to the dispensing of products from packaging containers and, more particularly, to dispensers for dispensing products initially provided in packaging containers.

### BACKGROUND

Products are typically shipped to retailers in bulk by enclosing multiple individual product units in a container, such as a carton or box. For example, canned beverages may be shipped to a retailer in a carton containing twelve or more individual cans. When the products are to be sold individually, the retailer must remove the individual product units from the carton and stack them on a display, such as a shelf.

Alternatives to the traditional package-ship-unpack-display model have been developed in an effort to improve operating efficiency. For example, U.S. Pat. No. 7,922,437 issued on Apr. 12, 2011, the entire contents of which are incorporated herein by reference, discloses a system for dispensing and displaying products packaged in a container. Specifically, the system includes a frame having a support structure, a product display area and an opening tool. The frame may be positioned on a retailer's shelf and loaded with product simply by placing a container comprising multiple units of product onto the support structure of the frame. As the container is being placed onto the support structure, the opening tool of the frame opens the container in such a manner that product rolls from the container and down to the product display area of the frame under the force of gravity. When one product is removed from the product display area, another product from within the dispenser frame moves down to the product display area under the force of gravity. Furthermore, multiple product dispensers may be positioned on a single display support surface, such as a store shelves. For example, a plurality of dispensers may be configured in a side-by-side orientation and supported on a single support surface.

A disadvantage to existing product dispensers is the potential instability of the dispenser due to unbalanced distribution of weight, a temporary shift in the center of gravity, or forces being applied to a front end of the dispenser. Such situations may occur when a container filled with an amount of product is loaded into the dispenser, when a limited amount of product remains in the dispenser, or when product is removed from the dispenser by a customer. Thus it may be advantageous to retain the dispenser on the support surface to minimize this instability.

Despite advances already made in the field, those skilled in the art continue with research and development efforts directed to apparatus and systems for dispensing products initially provided in packaging containers.

### SUMMARY

In one aspect, the disclosed product dispensing system may include a dispensing frame having a front end and a rear end, and including an upper support deck extending between the front end and the rear end, a lower support deck positioned below the upper support deck, the lower support deck extending between the front end and the rear end and defining a first product display area, an intermediate support deck positioned between the upper support deck and the lower support deck, the intermediate support deck extending between the front end and the rear end and defining a second product display area, and a heel positioned proximate the rear end of the frame having a channel formed by an upwardly and rearwardly extending opening. The product dispensing system may also include a dispenser platform to support the dispensing frame and a cleat that is attachable to the dispenser platform. The cleat may have an upwardly and rearwardly extending lip to insertably engage the channel.

In another aspect, the disclosed product dispensing system may include a container initially housing a plurality of products, a frame having longitudinally opposed front and rear ends and including an upper support deck extending at least partially between the front and rear ends, a lower support deck positioned below the upper support deck, the lower support deck defining a first product display area, and an intermediate support deck positioned between the upper support deck and the lower support deck, the intermediate support deck defining a second product display area, a heel positioned proximate the rear end of the frame having a channel formed by an upwardly and rearwardly extending opening; and an opening tool associated with the frame and arranged to open the container when the container is moved longitudinally along the upper support deck from the front end toward the rear end and allow the products to be at least partially dispensed from the container into the first and second product display areas. The product dispensing system may also include a dispenser platform to support at least one dispensing frame and at least one cleat that is attachable to the dispenser platform. The cleat may have an upwardly and rearwardly extending lip to insertably engage the channel.

In yet another aspect, disclosed is a method for dispensing a plurality of product initially provided in a container. The method may include the steps of (1) providing a dispenser including a frame having a front end and a rear end, the frame including an upper support deck extending at least partially between the front end and the rear end, a lower support deck positioned below the upper support deck, the lower support deck defining a first product display area, an intermediate support deck positioned between the upper support deck and the lower support deck, the intermediate support deck defining a second product display area, and a heel positioned proximate the rear end of the frame having a channel formed by an upwardly and rearwardly extending opening, the dispenser also including a dispenser platform to support at least one dispensing frame and at least one cleat that is attachable to the dispenser platform, the cleat having an upwardly and rearwardly extending lip to insertably engage the channel, (2) forming an opening in the container, (3) positioning the frame upon the dispenser platform such that the cleat engages the heel, and (4) positioning the container on the upper support deck such that a first quantity of products passes through the opening and moves toward the first product display area and, when the lower support deck is filled with the first quantity of products, a second quantity of products passes through the opening and moves toward the second product display area.

Other aspects of the disclosed product dispensing system and method will become apparent from the following detailed description, the accompanying drawings and the appended claims.

### BRIEF DESCRIPTION OF THE DRAWINGS

FIG. 1 is a front perspective view of one aspect of a disclosed product dispensing system with dispenser platform;

FIG. 2 is a side elevation view, in section, of the product dispensing system with dispenser platform of FIG. 1;

FIG. 3 is a front perspective view of a container of the product dispensing system of FIG. 1;

FIG. 4 is a front perspective view of the container of FIG. 3 shown in an open configuration;

FIG. 5 is an exploded front perspective view of another aspect of the disclosed product dispensing system with dispenser platform;

FIG. 6 is an exploded front perspective view of another aspect of the disclosed product dispensing system with dispenser platform;

FIG. 7 is an exploded front perspective view of another aspect of the disclosed product dispensing system with dispenser platform;

FIG. 8 is a side elevation view, in section, of another aspect of the disclosed product dispensing system with dispenser platform;

FIG. 9 is a top plan view of a portion of an upper support deck of a dispenser of the product dispensing system of FIG. 8;

FIG. 10 is a front perspective view of the container of the product dispensing system of FIG. 7;

FIG. 11 is a front perspective view of the container of FIG. 10 shown in an open configuration;

FIG. 12 is a side elevation view, in section, of another aspect of the disclosed product dispensing system with dispenser platform; and

FIG. 13 is an exploded front perspective view of the product dispensing system with dispenser platform of FIG. 12.

### DETAILED DESCRIPTION

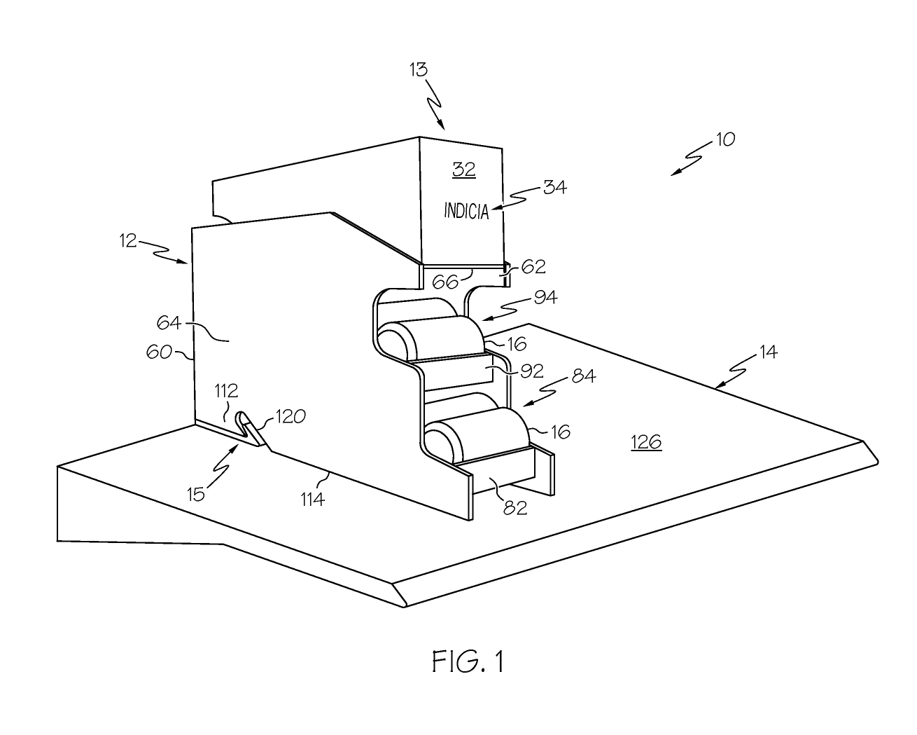

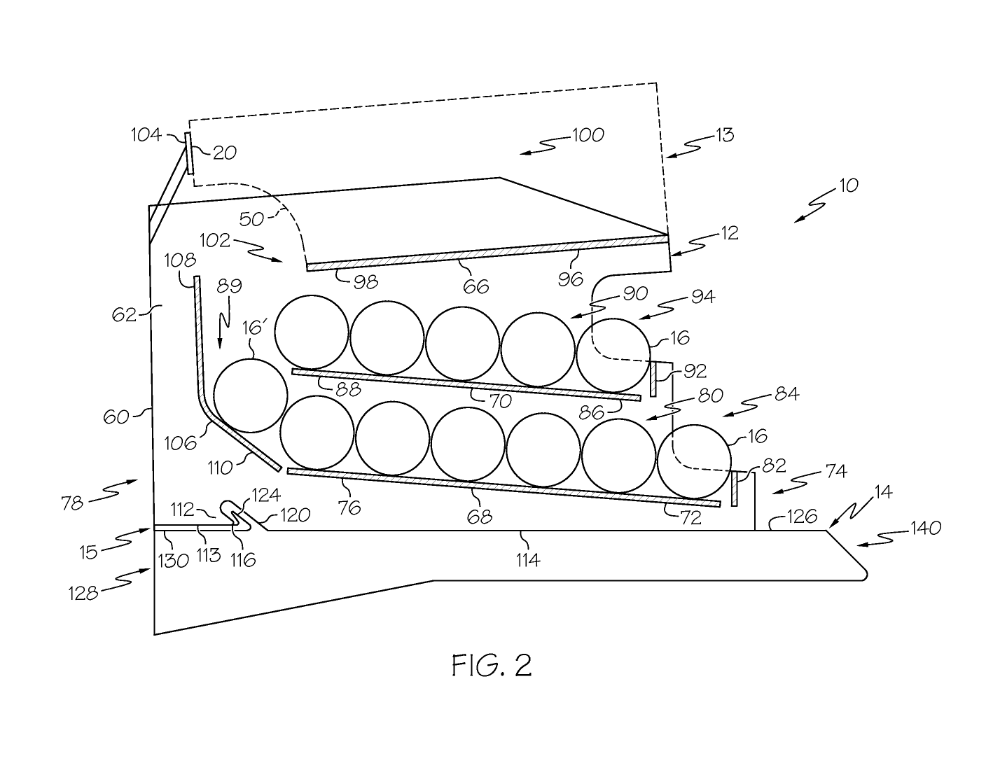

Referring to FIGS. 1 and 2, one aspect of the disclosed product dispensing system with dispenser platform, generally designated 10, may include a dispenser 12, a container 13, a dispenser platform 14, and a cleat 15. The container 13, as described in more detail herein, may initially house multiple units of product 16, such as cans (e.g., canned soft drinks), jars (e.g., jarred soup) or bottles (e.g., bottled sauce). The products 16 may be released from the container 13 into the dispenser 12 when the container 13 is opened and loaded onto the dispenser 12. The dispenser platform 14 may include any generally horizontal surface such as a table top, a counter top, or shelf. The cleat 15 may be disposed upon the dispenser platform 14 and engage a lower edge 114 of the dispenser 12 to prevent a rear end 78 of the dispenser 12 from lifting off of the dispenser platform 14 when a front end 74 of the dispenser 12 is acted upon by a forward or downward force.

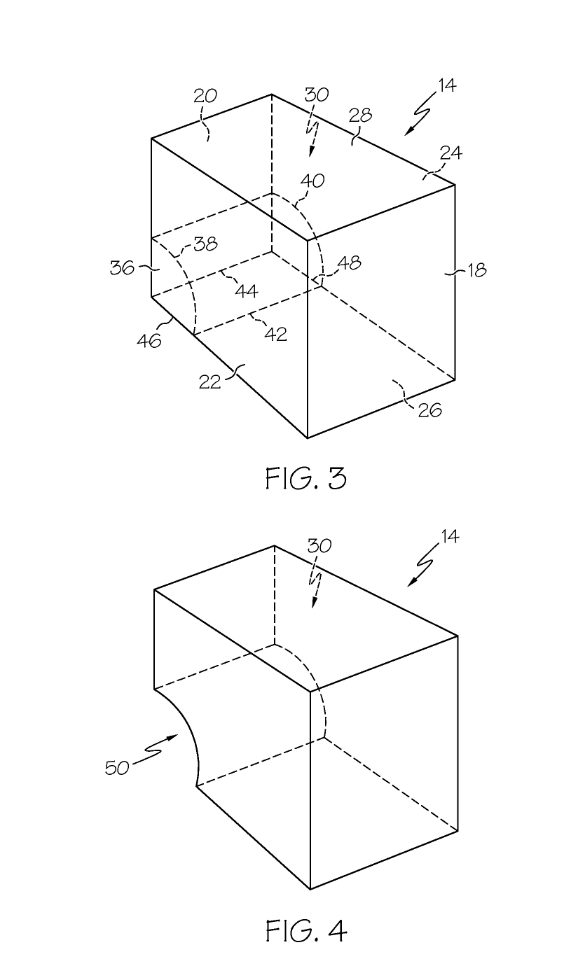

Referring next to FIGS. 3 and 4, the container 13 may be any container capable of initially housing the products 16 and beneficially interacting with the dispenser 12. For example, the container 13 may be a paperboard carton or a corrugated box having six walls 18, 20, 22, 24, 26, 28 that define an internal volume 30 for receiving the products 16. Opposed walls may define the front wall 18 and the rear wall 20 of the container 13. Opposed walls may define the left side wall 22 and the right side wall 24 of the container 13. Opposed walls may define the lower base wall 26 and the upper wall 28 of the container 13.

In accordance with well-established techniques, the container 13 may be assembled on a container machine using a container blank that has been pre-cut from a sheet of stock material. As one example, the stock material may be a paperboard-based material, such as C1S paperboard, which may have a coating (e.g., clay) on a first major surface thereof, which may form the outer surface of the container 13, and an uncoated second major surface. As another example, the stock material may be C2S paperboard, which may have a coating (e.g., clay) on both major surfaces thereof. Optionally, the outer surface 32 (illustrated in FIG. 1) of the container 13 may be marked with various container indicia 34 (FIG. 1), such as printed text and graphics, for example to identify the type of product 16 or the manufacturer of the product 16.

Still referring to FIG. 3, the container 13 may include a removable opening feature 36. The removable opening feature 36 may be defined by weakened severance lines 38, 40, 42, 44, 46, 48 formed in the rear wall 20, left side wall 22, right side wall 24 and the base wall 26 of the container 13. The weakened severance lines 38, 40, 42, 44, 46, 48 may be formed by weakening the container 13, such as with score lines, perforations or zipper-like cuts, to facilitate tearing of the container 13 along the weakened severance lines 38, 40, 42, 44, 46, 48.

Thus, as shown in FIG. 4, the removable opening feature 36 may be removed from the container 13 to form an opening 50 to access the internal volume 30 of the container 13. The opening 50 may extend generally laterally between the left side wall 22 and the right side wall 24 of the container 13 and may be positioned proximate the rear wall 20 of the container 13, such that the products 16 (FIG. 2) may exit the container 13 through the opening 50. Those skilled in the art will appreciate that the step of removing the removable opening feature 36 from the container 13 may be performed prior to loading the container 13 onto the dispenser 12.

Referring back to FIGS. 1 and 2, the dispenser 12 may include a frame 60 that supports the container 13 in a desired configuration (FIG. 2). The frame 60 may include a first (e.g., right) side wall 62, a second (e.g., left) side wall 64, an upper support deck 66, a lower support deck 68 and one or more intermediate support decks 70 (only one intermediate support deck 70 is shown by example in FIGS. 1 through 3). The right side wall 62 may be laterally spaced from the left side wall 64 and may be generally parallel to the left side wall 64.

The lower support deck 68 may laterally extend between the right side wall 62 and the left side wall 64 of the frame 60 and may include a front end 72 that longitudinally extends toward the front end 74 of the frame 60 and a rear end 76 that longitudinally extends toward the rear end 78 of the frame 60. Therefore, the lower support deck 68 and the side walls 62, 64 may define a lower level 80 of the frame 60.

The lower support deck 68 may be inclined from the front end 72 to the rear end 76 (i.e., the rear end 76 may be elevated relative to the front end 72) such that products 16 deposited proximate the rear end 76 of the lower support deck 68 roll down to the front end 72 of the lower support deck 68 under the force of gravity. The extent of the incline of the lower support deck 68 may be dictated by, among other things, the coefficient of friction of the material used to form the frame 60 and the shape of the products 16 to be dispensed by the dispenser 12.

A lower stop 82 may be positioned proximate the front end 72 of the lower support deck 68 to prevent products 16 from rolling beyond the front end 72 of the lower support deck 68. Therefore, the stop 82 may collect products 16 at the front end 72 of the lower support deck 68, thereby defining a first product display area 84 proximate the front end 72 of the lower support deck 68.

The intermediate support deck 70 may be positioned between the upper support deck 66 and the lower support deck 68. The intermediate support deck 70 may laterally extend between the right side wall 62 and the left side wall 64 of the frame 60 and may include a front end 86 that longitudinally extends toward the front end 74 of the frame 60 and a rear end 88 that longitudinally extends toward, but not to, the rear end 78 of the frame 60. Therefore, the intermediate support deck 70 and the side walls 62, 64 may define an intermediate level 90 of the frame 60.

The spacing between the rear end 88 of the intermediate support deck 70 and the rear end 78 of the frame 60 may define an intermediate opening 89, which may function as a chute to allow products 16 to move from the intermediate level 90 down to the lower level 80 of the frame 60 under the force of gravity.

The intermediate support deck 70 may be inclined from the front end 86 to the rear end 88 (i.e., the rear end 88 may be elevated relative to the front end 86) such that products 16 deposited proximate the rear end 88 of the intermediate support deck 70 roll down to the front end 86 of the intermediate support deck 70 under the force of gravity. The extent of the incline of the intermediate support deck 70 may be dictated by, among other things, the coefficient of friction of the material used to form the frame 60 and the shape of the products 16 to be dispensed by the dispenser 12.

An intermediate stop 92 may be positioned proximate the front end 86 of the intermediate support deck 70 to prevent products 16 from rolling beyond the front end 86 of the intermediate support deck 70. Therefore, the stop 92 may collect products 16 at the front end 86 of the intermediate support deck 70, thereby defining a second product display area 94 proximate the front end 86 of the intermediate support deck 70. The second product display area 94 may be longitudinally displaced (e.g., inwardly) relative to the first product display area 84. The second product display area 94 may also be vertically displaced (e.g., upwardly) relative to the first product display area 84.

The upper support deck 66 may laterally extend between the right side wall 62 and the left side wall 64 of the frame 60 and may include a front end 96 that longitudinally extends toward the front end 74 of the frame 60 and a rear end 98 that longitudinally extends toward, but not to, the rear end 78 of the frame 60. Therefore, the upper support deck 66 and the side walls 62, 64 may define an upper level 100 of the frame 60.

The spacing between the rear end 98 of the upper support deck 66 and the rear end 78 of the frame 60 may define an upper opening 102, which may function as a chute to allow products 16 to move from the upper level 100 down to the intermediate 90 and lower 80 levels of the frame 60 under the force of gravity.

The upper support deck 66 may be declined from the front end 96 to the rear end 98 (i.e., the front end 96 may be elevated relative to the rear end 98). Therefore, products 16 supported on the upper support deck 66 may roll under the force of gravity down to the rear end 98 of the upper support deck 66, through the opening 102, to the lower and intermediate levels 80, 90 of the frame 60 and, ultimately, to the first product display area 84 and the second product display 94.

Optionally, a container stop 104 may be connected proximate the rear end 78 of the frame 60. The stop 104 may extend into the upper level 100 of the frame 60 to inhibit rearward horizontal movement of the container 13 along the upper support deck 66 beyond the stop 104.

A guide 106 may be connected proximate the rear end 78 of the frame 60. The guide may laterally extend between the right side wall 62 and the left side wall 64 of the frame 60 and may include a generally vertical upper end 108 that extends toward the upper support deck 66 and a declined lower end 110 that extends toward the rear end 76 of the lower support deck 68. The guide 106 may extend from proximate the upper opening 102 in the upper level 100 defined by the upper support deck 66, down through the intermediate opening 89 in the intermediate level 90 defined by the intermediate support deck 70 and, ultimately, down to the lower level 80 proximate the rear end 76 of the lower support deck 68.

Thus, the guide 106 may receive products 16 exiting through the opening 50 in the container 13 and may guide the products 16 down proximate the rear end 76 of the lower support deck 68, thereby allowing the products 16 guided to the lower level 80 to ultimately move to the first product display area 84. Once the lower level 80 of the frame 60 has been filled with products 16 such that the opening 89 in the intermediate level 90 is bridged by a product 16′ (FIG. 3), the guide 106 may guide the products 16 down proximate the rear end 88 of the intermediate support deck 70, thereby allowing the products 16 guided to the intermediate level 90 to ultimately move to the second product display area 94.

The product dispensing system 10 may be assembled by opening the container 13 (e.g., tearing away the removable opening feature 36 at the severance lines 38, 40, 42, 46, 48) and urging the opened container 13 along the upper support deck 66 of the frame 60 until the rear wall 20 of the container 13 comes into abutting engagement with the stop 104. With the opened container 13 loaded onto the dispenser 12, the force of gravity may urge the products 16 housed in the container 13 through the opening 50 in the container 13, down through the opening 102 in the upper level 100 of the frame 60 and, ultimately, to the first and second product display areas 84, 94.

A heel 112 may be disposed at a lower longitudinal edge 114 of each side wall 62, 64 proximate the rear end 78 of the frame 60. The heel 112 may include a front portion 116 terminating in a tip 118 and a channel 120 formed by an upwardly and rearwardly extending curved opening. Alternatively, the channel may have an upwardly and rearwardly extending straight-edged opening. The channel 120 may be suitably sized and shaped to engage an upwardly and rearwardly extending lip 124 of the cleat 15. A lower longitudinal edge 113 of the heel 112 may be vertically displaced relative to the lower edge 114 of the remaining portion of the side walls 62, 64 of the frame 60, such that the dispenser frame 60 sits at a level when mounted atop the dispenser platform 14. The vertical displacement may be substantially equivalent to the thickness of the cleat 15 which protrudes above the top surface 126 of the dispenser platform 14.

The dispenser platform 14 may be a self-standing structure or may be one of a plurality of support platforms. The dispenser platform 14 may be, for example, a shelf such as those used in retail shelving assemblies or other commercial shelving assemblies to hold and display merchandise. The dispenser platform 14 may include the generally flat top surface 126 to support at least one dispenser 12. In use, a plurality of dispensers 12 may be positioned in a side-by-side configuration upon the dispenser platform 14. The cleat 15 may be attached, fastened, mounted, or otherwise connected or affixed to the top surface 126 of the dispenser platform 14 proximate a rear end 128.

To install the dispenser 12 on the dispenser platform 14, the rear end 78 of the frame 60 may be positioned behind the cleat 15 such that the lip 124 is proximate the front portion 116 of the heel 112 in front of the channel 120. The dispenser 12 may be moved toward the front end 140 of the dispenser platform 14 so that the lip 124 contacts the interior of the channel 120. Once engaged, the lip 124 may provide a structural restraint to prevent the rear end 78 of the frame 60 from lifting off of the top surface 126 of the dispenser platform 14 when the front end 74 of the frame 60 is acted upon by a forward or downward force, such as when loading the container 13 onto the upper support deck 66 or when removing product 16 from the first product display area 84 or the second product display area 94.

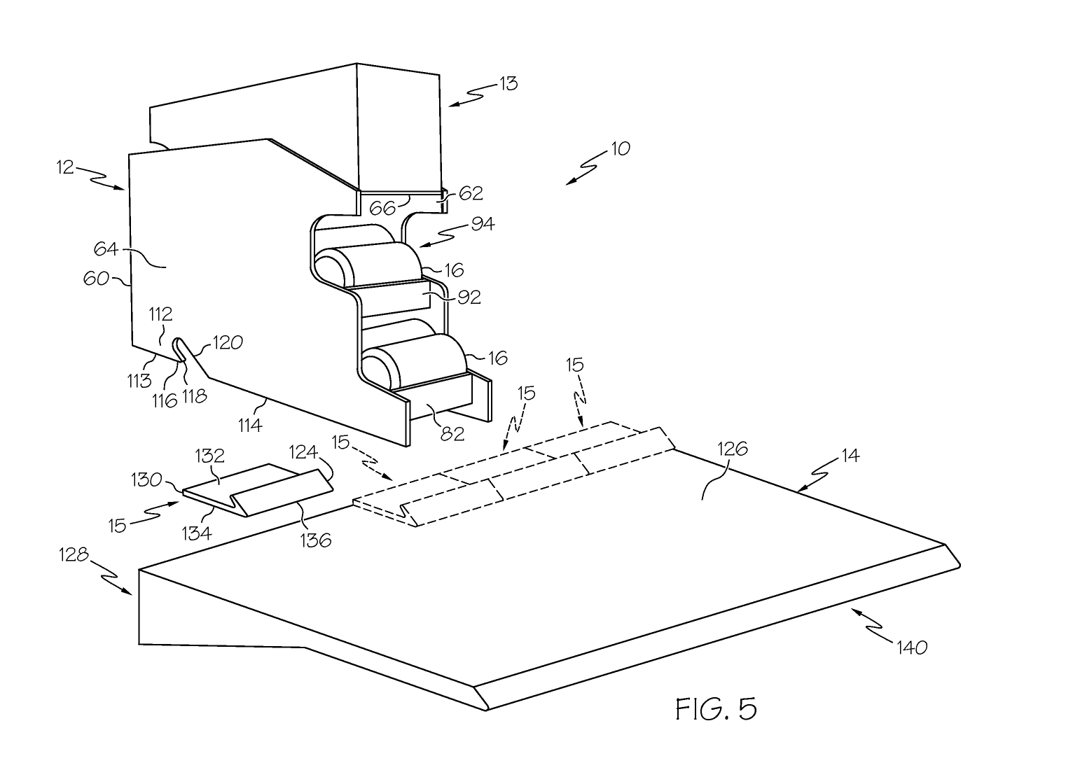

Referring to FIG. 5, another aspect of the disclosed dispensing system 10 may include at least one dispenser platform 14 and at least one affixable cleat 15. The cleat 15 may include a mounting portion 130 that may be mounted on the top surface 126 of the dispenser platform 14 to attach the cleat 12 to the dispenser platform 14. The mounting portion 130 may include a continuous and planar top surface 132 and bottom surface 134. A front end 136 of the mounting portion 130 may have an upwardly and rearwardly extending, generally hook-shaped, curved lip 124 suitable for engaging against the interior of the channel 120. Alternatively, the lip 124 may be straight having a horizontal ledge suitable for engaging against the interior of the channel 120. Alternatively, the lip 124 may include a plurality of straight or curved, small, spaced-apart lips arranged along the longitudinal front end 136 of the mounting portion 130 for engaging against the interior of the channel 120.

The bottom surface 131 of the mounting portion 130 may be affixed to the top surface 126 of the dispenser platform 14 proximate the rear end 128 such that front end 136 of the mounting portion 130 is away from the rear end 128 of the dispenser platform 14 and the lip 124 extends toward the rear end 128 of the dispenser platform 14, generally parallel to a leading longitudinal edge of the dispenser platform 14. For example, the mounting portion 130 may be adhered to the top surface 126 of the dispenser platform 14 by any suitable adhesive or bonding agent in contact with both the top surface 126 of the dispenser platform 14 and the bottom surface 134 of the mounting portion 130. The use of the cleat 15 provides for mounting to the dispenser platform 14 without the need for tools, fastening hardware, or other assembly materials. The top surface 126 of the dispenser platform 14 may include at least one longitudinally disposed recess suitably sized to receive the mounting portion 130 of the cleat 15, such that the top surface 132 of the mounting portion 130 is in a coplanar relationship with the top surface 126 of the dispenser platform 14. In such configuration, the lower edge 113 of the heel 112 may be level with the remaining portion of the lower edge 114 of the side walls 62, 64 of the frame 60.

In one implementation of the disclosed dispensing system 10, a plurality of cleats 15 may be affixed to the top surface 126 of the dispenser platform 14. As illustrated in FIG. 5, a single cleat 15 is shown in solid lines and additional cleats 15 are shown in broken lines. The cleat 15 may have a lateral width at least equivalent to a lateral width of the dispenser frame 60 measured from an exterior of the right side wall 62 to the exterior of the left side wall 64. It can be appreciated by one skilled in the art that the total number of cleats 15 mounted to the dispenser platform 14 may vary depending at least upon the dimensions of the dispenser platform 14 and the dimensions of the dispenser frame 60. Alternatively, the cleat 15 may have a lateral width sufficient to span two or more dispensers 12 configured in a side-by-side orientation, such that the lip 124 may engage the channels 120 of each dispenser frame 60. It can be appreciated by one skilled in the art that the lateral width of the cleat 15 may be limited only by the lateral width of a given dispenser platform 14.

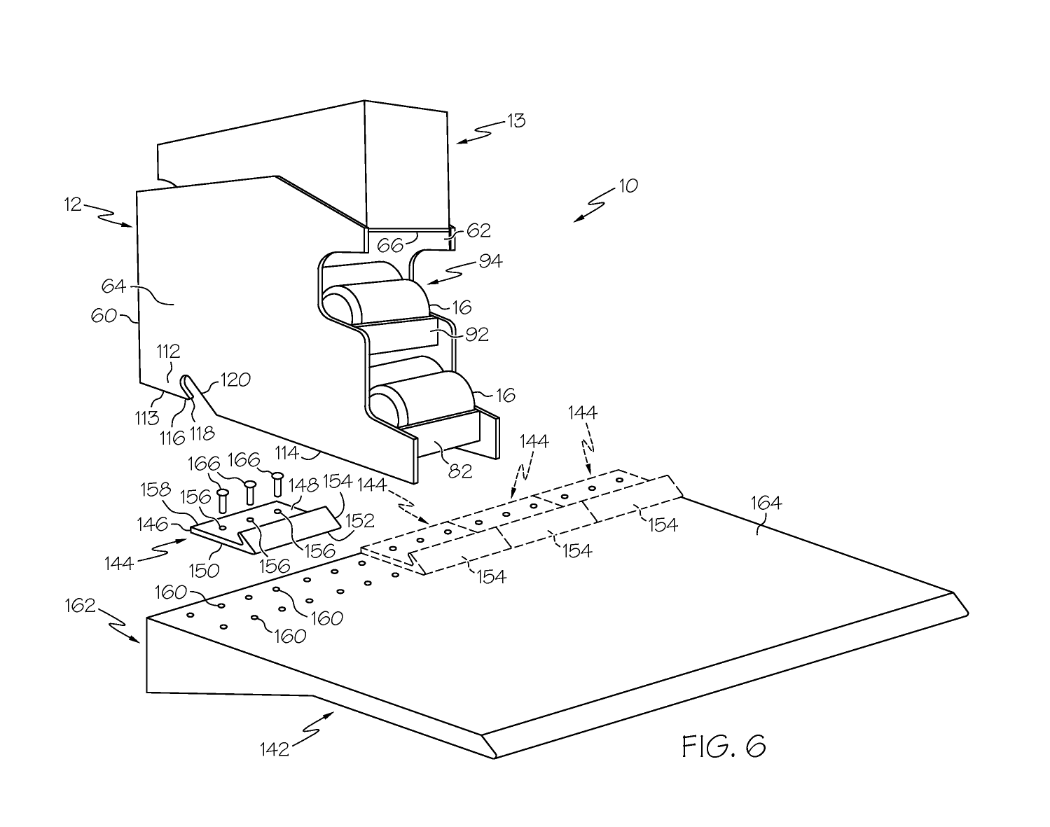

Referring to FIG. 6, another aspect of the disclosed dispensing system 10 may include at least one dispenser platform 142 and at least one attachable cleat 144. A mounting portion 146 of the cleat 144 may have a continuous and planar top surface 148 and bottom surface 150. A front end 152 of the mounting portion 146 may have an upwardly and rearwardly extending, generally hook-shaped, curved lip 154 suitable for engaging against the interior of the channel 120 of the heel 112 of the dispenser frame 60. Alternatively, the lip 154 may be straight having a horizontal ledge suitable for engaging against the interior of the channel 120. Alternatively, the lip 154 may include a plurality of straight or curved, small, spaced-apart lips arranged along the longitudinal front end 152 of the mounting portion 146 for engaging against the interior of the channel 120.

The mounting portion 146 may include a plurality of spaced apart mounting apertures 156 extending longitudinally proximate a rear end 158 of the mounting portion 146. The dispenser platform 142 may include at least one row of a plurality of platform apertures 160 extending longitudinally proximate a rear end 162 of the dispenser platform 142. The cleat 144 may be fastened to the to a top surface 164 of the dispenser platform 142 proximate a rear end 162 such that the front end 152 of the mounting portion 146 is away from the rear end 162 of the dispenser platform 142 and the lip 154 extends toward the rear end 162 of the dispenser platform 142, generally parallel to a leading longitudinal edge of the dispenser platform 142. For example, the mounting portion 146 may be fastened to the top surface 164 of the dispenser platform 142 by aligning the apertures 156 of the mounting portion 146 with subjacent apertures 160 of the dispenser platform 142 and securing the mounting portion 146 to the dispenser platform 142 by a plurality of suitable mechanical fasteners 166, such as screws, nuts and bolts, or the like. The top surface 164 of the dispenser platform 142 may include at least one longitudinally disposed recess suitably sized to receive the mounting portion 146 of the cleat 144, such that the top surface 148 of the mounting portion 146 is in a coplanar relationship with the top surface 164 of the dispenser platform 142. In such configuration, the lower edge 113 of the heel 112 may be level with the remaining portion of the lower edge 114 of the side walls 62, 64 of the frame 60.

In one implementation of the disclosed dispensing system 10, a plurality of cleats 144 may be fastened to the top surface 164 of the dispenser platform 142. As illustrated in FIG. 6, a single cleat 144 is shown in solid lines and additional cleats 144 are shown in broken lines. The cleat 144 may have a lateral width at least equivalent to a lateral width of the dispenser frame 60 measured from an exterior of the right side wall 62 to the exterior of the left side wall 64. It can be appreciated by one skilled in the art that the total number of cleats 144 mounted to the dispenser platform 142 may vary depending at least upon the dimensions of the dispenser platform 142 and the dimensions of the dispenser frame 60. Alternatively, the cleat 144 may have a lateral width sufficient to span two or more dispensers 12 configured in a side-by-side orientation, such that the lip 154 may engage the channels 120 of each dispenser frame 60. It can be appreciated by one skilled in the art that the lateral width of the cleat 144 may be limited only by the lateral width of a given dispenser platform 142.

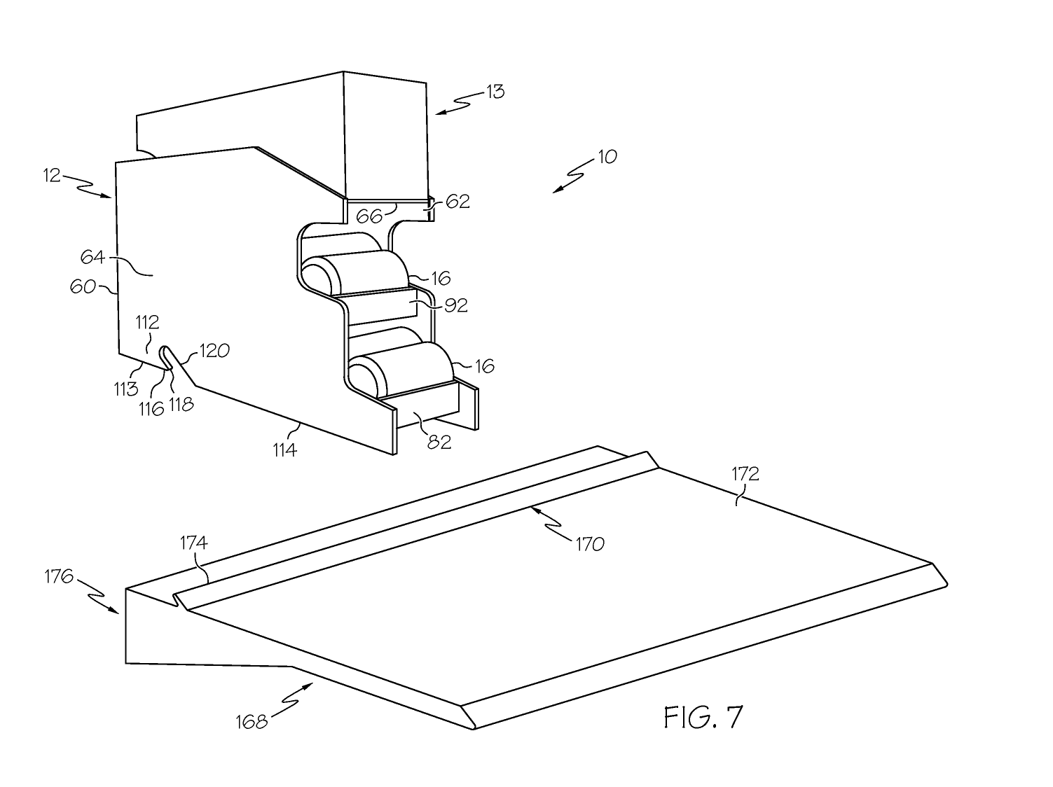

Referring to FIG. 7, another aspect of the disclosed dispensing system 10 may include at least one dispenser platform 168 and at least one integral cleat 170. The cleat 170 may be integral to a top surface 172 of the dispenser platform 168 and have an upwardly and rearwardly extending, generally hook-shaped, curved lip 174 suitable for engaging against the interior of the channel 120 of the heel 112 of the dispenser frame 60. The lip 172 may extend from the top surface 172 of the dispenser platform 168 spaced away from and extending toward a rear end 176 of the dispenser platform 168, generally parallel to a leading longitudinal edge of the dispenser platform 168. Alternatively, the lip 174 may be straight having a horizontal ledge suitable for engaging against the interior of the channel 120. Alternatively, the lip 174 may include a plurality of straight or curved, small, spaced-apart lips arranged longitudinally along the top surface 172 of the dispenser platform 168 for engaging against the interior of the channel 120.

In one implementation of the disclosed dispensing system 10, at least one cleat 170 may be integral to the top surface 172 of the dispenser platform 168. The cleat 168 may have a lateral width at least equivalent to the lateral width of the dispenser frame 60 measured from the exterior of the right side wall 62 to the exterior of the left side wall 64. It can be appreciated by one skilled in the art that the total number of cleats 170 integral to the dispenser platform 168 may vary depending at least upon the dimensions of the dispenser platform 168 and the dimensions of the dispenser frame 60. Alternatively, as illustrated in FIG. 7, the cleat 170 may have a lateral width sufficient to span two or more dispensers 12 configured in a side-by-side orientation, such that the lip 174 may engage the channels 120 of each dispenser frame 60. It can be appreciated by one skilled in the art that the lateral width of the cleat 170 may be limited only by the lateral width of a given dispenser platform 168.

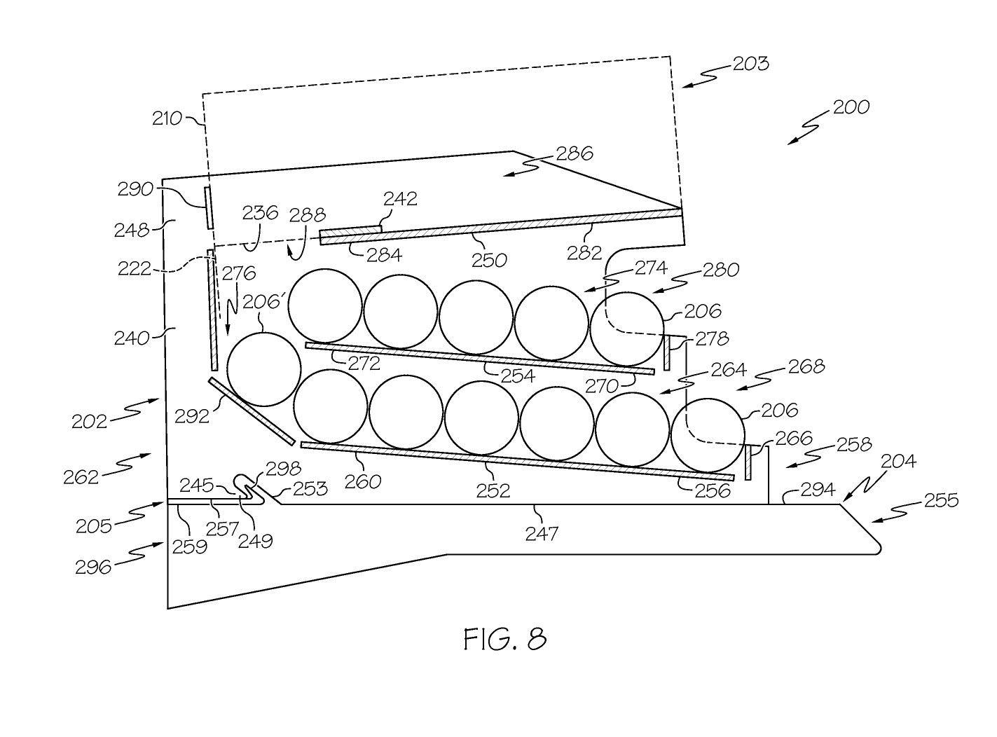

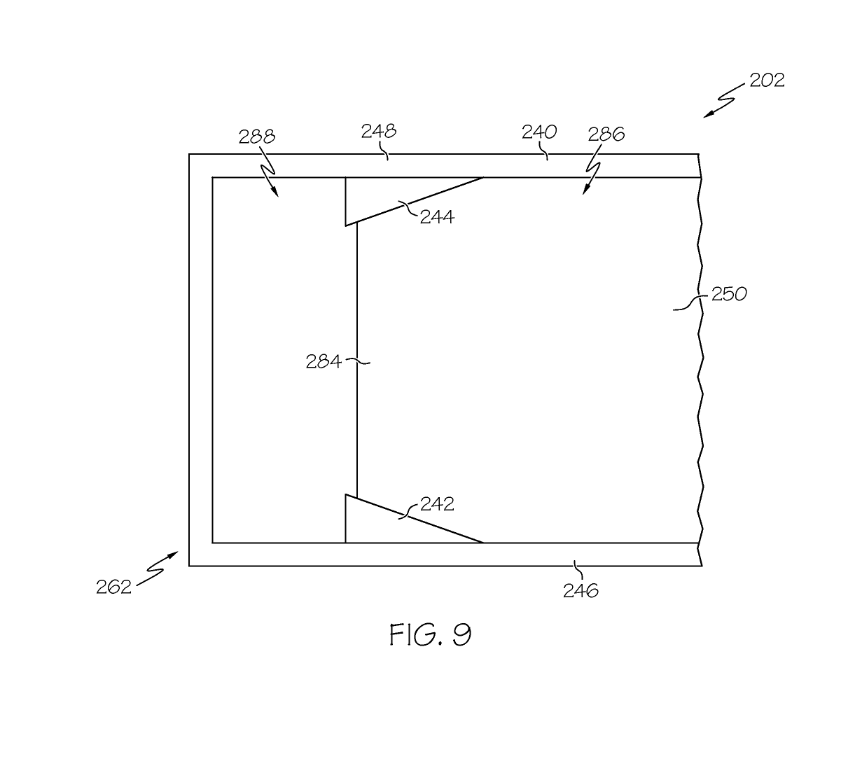

Referring next to FIGS. 8 and 9, another aspect of the disclosed product dispensing system with dispenser platform, generally designated 200, may include a dispenser 202, a container 203, a dispenser platform 204, and a cleat 205. The container 203 may initially house multiple units of product 206 and may be opened to release the products 206 into the dispenser 202 when the container 203 is loaded onto the dispenser 202. The dispenser platform 204 may include any generally horizontal surface such as a table top, a counter top, or shelf. The cleat 205 may be disposed upon the dispenser platform 204 and engage the dispenser 202 to prevent a rear end of the dispenser 202 from lifting off of the dispenser platform 204 when a front end of the dispenser 202 is acted upon by a forward or downward direction.

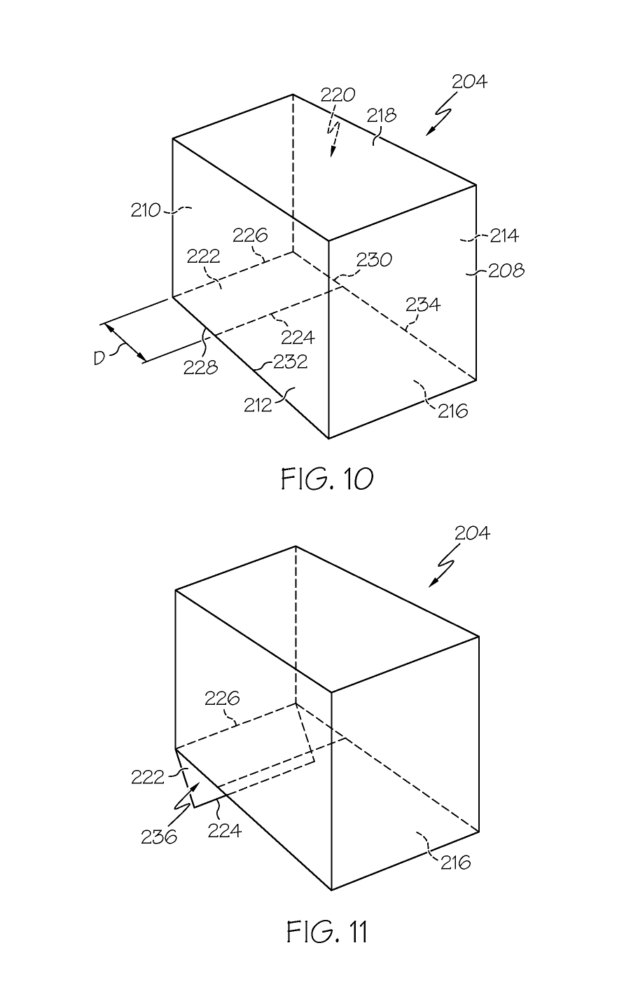

Referring to FIGS. 10 and 11, the container 203 may have six walls 208, 210, 212, 214, 216, 218 that define an internal volume 220 for receiving the products 206 (FIG. 10). Opposed walls may define the front wall 208 and the rear wall 210 of the container 203. Opposed walls may define the left side wall 212 and the right side wall 214 of the container 203. Opposed walls may define the lower base wall 216 and the upper wall 218 of the container 203.

The base wall 216 of the container 203 may define an access panel 222 that is openable to release the products 206 (FIG. 11) from the container 203. The access panel 222 may be defined by a free edge 224, a pre-formed pivot line 226, a first severance line 228 and a second severance line 230.

The pre-formed pivot line 226 may laterally extend across the base wall 216 (or the edge between the base wall 216 and the rear wall 210) of the container 203 from proximate the left side wall 212 to proximate the right side wall 214. The longitudinal distance D between the pre-formed pivot line 226 and the free edge 224 may define the longitudinal length of the access panel 222, and may be greater than the greatest diameter of the products 206 housed in the container 203.

The pre-formed pivot line 226 may be formed by weakening the container 203 along the pre-formed pivot line 226. Examples of weakening techniques useful in forming the pre-formed pivot line 226 include scoring the container 203, forming a crease in the container 203 and forming perforations in the container 203.

The first severance line 228 may longitudinally extend from the free edge 224 to the pre-formed pivot line 226. For example, the first severance line 228 may extend from the free edge 224 to the pre-formed pivot line 226 proximate the edge 232 between the base wall 216 and the left side wall 212.

The second severance line 230 may longitudinally extend from the free edge 224 to the pre-formed pivot line 226. For example, the second severance line 230 may extend from the free edge 224 to the pre-formed pivot line 226 proximate the edge 234 between the base wall 216 and the right side wall 214.

The first and second severance lines 228, 230 may be weakened to make it easier to sever the first and second severance lines 228, 230. However, the first and second severance lines 228, 230 may have sufficient strength such that the first and second severance lines 228, 230 are not severed merely due to the weight of the products 206 housed in the container 203 acting on the access panel 222. Several examples of techniques that may be used to weaken the first and second severance lines 228, 230 include forming perforations in the container 203 along the first and second severance lines 228, 230, scoring the container 203 and forming creases in the container 203.

The free edge 224 may laterally extend across the base wall 216 of the container 203 from proximate the left side wall 212 to proximate the right side wall 214. The free edge 224 may be spaced a longitudinal distance D from the pre-formed pivot line 226.

In one implementation, the free edge 224 may be defined by a severance line that must be severed to free the free edge 224. In a first expression, the free edge 224 may be freed by severing the severance line defining the free edge 224 prior to loading the container 203 onto the dispenser 202. For example, the free edge 224 may be freed by pulling a zipper strip from the container 203 prior to loading the container 203 onto the dispenser 202. In a second expression, the free edge 224 may be freed by severing the severance line defining the free edge 224 as the container 203 is being loaded onto the dispenser 202.

As shown in FIG. 11, when the free edge 224 is free and the first and second severance lines 228, 230 have been severed, the access panel 222 may pivot relative to the base wall 216 about the pre-formed pivot line 226 to form an opening 236. The opening 236 may be of a sufficient size and shape to allow products 206 (FIG. 8) to pass therethrough.

In one implementation, the first and second severance lines 228, 230 may be severed to release the access panel 222 as the container 203 is loaded onto the dispenser 202, as described in greater detail herein. In another implementation, the first and second severance lines 228, 230 may be severed to release the access panel 222 prior to loading the container 203 onto the dispenser 202, such as by manually severing the first and second severance lines 228, 230 (e.g., with a knife or box cutter).

Referring back to FIGS. 8 and 9, the dispenser 202 may include a frame 240 and one or more opening tools 242, 244. The frame 240 may support the container 203 in a desired configuration, as shown in FIG. 8. The opening tools 242, 244 may sever the first and second severance lines 228, 230 (FIG. 10) to release the access door 222 and form the opening 236 (FIG. 11) in the container 203 as the container 203 is loaded onto the frame 240, thereby releasing the products 206 from the container 203 to the dispenser 202.

The frame 240 may include left and right side walls 246, 248, an upper support deck 250, a lower support deck 252 and an intermediate support deck 254 positioned between the upper support deck 250 and the lower support deck 252. The right side wall 248 may be laterally spaced from the left side wall 246 and may be generally parallel with the left side wall 246.

The lower support deck 252 may laterally extend between the side walls 246, 248, and may include a front end 256 that longitudinally extends toward the front end 258 of the frame 240 and a rear end 260 that longitudinally extends toward the rear end 262 of the frame 240. Therefore, the lower support deck 252 and the side walls 246, 248 may define a lower level 264 of the frame 240.

The lower support deck 252 may be inclined from the front end 256 to the rear end 260, and may include a lower stop 266 positioned proximate the front end 256 of the lower support deck 252, thereby defining a first product display area 268 proximate the front end 256 of the lower support deck 252.

The intermediate support deck 254 may be positioned between the upper support deck 250 and the lower support deck 252. The intermediate support deck 254 may laterally extend between the side walls 246, 248, and may include a front end 270 that longitudinally extends toward the front end 258 of the frame 240 and a rear end 272 that longitudinally extends toward, but not to, the rear end 262 of the frame 240. Therefore, the intermediate support deck 254 and the side walls 246, 248 may define an intermediate level 274 of the frame 60.

The spacing between the rear end 272 of the intermediate support deck 254 and the rear end 262 of the frame 240 may define an intermediate opening 276, which may function as a chute to allow products 206 to move from the intermediate level 274 down to the lower level 264 of the frame 240 under the force of gravity.

The intermediate support deck 254 may be inclined from the front end 270 to the rear end 272, and may include an intermediate stop 278 positioned proximate the front end 270 of the intermediate support deck 254, thereby defining a second product display area 280 proximate the front end 270 of the intermediate support deck 254.

Additional intermediate support decks (not shown), which may define additional intermediate levels and associated product display areas, may be provided between the upper support deck 250 and the lower support deck 252 without departing from the scope of the present disclosure.

The upper support deck 250 may laterally extend between the side walls 246, 248, and may include a front end 282 that longitudinally extends toward the front end 258 of the frame 240 and a rear end 284 that longitudinally extends toward, but not to, the rear end 262 of the frame 240. Therefore, the upper support deck 250 and the side walls 246, 248 may define an upper level 286 of the frame 240.

The spacing between the rear end 284 of the upper support deck 250 and the rear end 262 of the frame 240 may define an upper opening 288, which may function as a chute to allow products 206 to move from the upper level 286 down to the intermediate 274 and lower 264 levels of the frame 240 under the force of gravity.

The upper support deck 250 may be declined from the front end 282 to the rear end 284 such that products 206 supported on the upper support deck 250 may roll under the force of gravity down to the rear end 284 of the upper support deck 250, through the upper opening 288, to the lower and intermediate levels 264, 274, respectively, of the frame 240 and, ultimately, to the first and second product display areas 268, 280.

An optional container stop 290 may be disposed proximate the rear end 262 of the frame 240. The stop 290 may laterally extend between the side walls 246, 248 of the frame 60 proximate the upper level 286 of the frame 240 to inhibit rearward horizontal movement of the container 203 along the upper support deck 250 beyond the stop 290.

A guide 292 may be connected proximate the rear end 262 of the frame 240. The guide 292 may receive products 206 exiting through the opening 236 (FIG. 11) in the container 203 and may guide the products 206 down through the upper opening 288 in the upper level 286, through the intermediate opening 276 in the intermediate level 274 and, ultimately, proximate the rear end 260 of the lower support deck 252, thereby allowing the products 206 to move to the first product display area 268 under the force of gravity. Once the lower level 264 of the frame 240 has been filled with products 206 such that the opening 276 in the intermediate level 274 is bridged by a product 206′ (FIG. 8), the products 206 guided through the opening 288 in the upper level 286 may accumulate on the intermediate support deck 254, thereby allowing the products 206 to move to the second product display area 280 under the force of gravity.

The opening tools 242, 244 may be positioned in the upper level 286 of the frame 240 to sever the first and second severance lines 228, 230 (FIG. 10), respectively, of the container 203 as the container 203 is urged along the upper support deck 250 of the frame 240. The type of opening tools 242, 244 used, as well as the position of the opening tools 242, 244 relative to the frame 240, may depend on the configuration of the access panel 222 (FIG. 11) of the container 203, among other things.

As illustrated in FIG. 9, in one particular construction, the opening tools 242, 244 may be cutting elements (e.g., knife blades) that inwardly protrude from the side walls 246, 248 proximate the rear end 284 of the upper support deck 250. For example, opening tool 242 may be connected to the left side wall 246 of the frame 240 and opening tool 244 may be connected to the right side wall 248 of the frame 240. Therefore, the opening tools 242, 244 may sever the first and second severance lines 228, 230 (FIG. 10) as the container 203 is urged toward the stop 290 along the upper support deck 250 of the frame 240, thereby allowing the access panel 222 to pivot about the pre-formed pivot line 226 to form the opening 236 (FIG. 11) in the container 203.

At this point, those skilled in the art will appreciate that opening tools 242, 244 are only one specific example of suitable opening tools, and that various alternative opening tools may be used without departing from the scope of the present disclosure. As one example, the opening tool may include a cutting element positioned to form access panels in the container 203 that open laterally outward, as described in U.S. Pat. No. 7,922,437 (discussed above). As another example, the opening tool may include a forward-protruding catch element, such as the forward-protruding catch element disclosed in U.S. Ser. No. 12/891,391 filed on Sep. 27, 2010, the entire contents of which are incorporated herein by reference, or the forward-protruding catch element disclosed in U.S. Ser. No. 13/032,734 filed on Feb. 23, 2011, the entire contents of which are incorporated herein by reference. As yet another example, the opening tool may include a rear-protruding catch element, such as the rear-protruding catch element disclosed in U.S. Ser. No. 12/970,683 filed on Dec. 16, 2010, the entire contents of which are incorporated herein by reference.

The product dispensing system 200 may be assembled to dispense products 206 by positioning the container 203 onto the front end 282 of the upper support deck 250 of the frame 240 and urging the container 203 along the upper support deck 250 toward the stop 290. As the container moves relative to the opening tools 242, 244, the opening tools 242, 244 may sever the first and second severance lines 228, 230, thereby allowing the access panel 222 to pivot relative to the base wall 216 about the pre-formed pivot line 226. As the container 203 continues to move rearward, the access panel 222 may drop through the opening 288 in the upper level 286 of the frame 240 to form the opening 236 in the container 203, thereby allowing the products 206 in the container 203 to exit the container 203 through the opening 236 under the force of gravity. As the products 206 exit the container 203, the guide 292 may guide the products 206 down through the opening 288 in the upper level 286 of the frame 240 and, ultimately, to the first and second product display areas 268, 280.

A heel 245 may be disposed at a lower longitudinal edge 247 of each side wall 246, 248 proximate the rear end 262 of the frame 240. The heel 245 may include a front portion 249 terminating in a tip 251 and a channel 253 formed by an upwardly and rearwardly extending curved opening. Alternatively, the channel 253 may have an upwardly and rearwardly extending straight-edged opening. The channel 253 may be suitably sized and shaped to engage an upwardly and rearwardly extending lip 298 of the cleat 205. A lower longitudinal edge 257 of the heel 245 may be vertically displaced relative to the lower edge 247 of the remaining portion of the side walls 246, 248 of the frame 240, such that the dispenser frame 240 sits at a level when mounted atop the dispenser platform 204. The vertical displacement may be substantially equivalent to the thickness of the cleat 205 which protrudes above the top surface 294 of the dispenser platform 204.

The dispenser platform 204 may be a self-standing structure or may be a one of a plurality of support platforms. The dispenser platform 204 may be, for example, a shelf such as those used in retail shelving assemblies or other commercial shelving assemblies to hold and display merchandise. The dispenser platform 204 may include a generally flat top surface 294 to support at least one dispenser 202. In use, a plurality of dispensers 202 may be positioned in a side-by-side configuration upon the dispenser platform 204. The cleat 205 may be attached, fastened, mounted, or otherwise connected or affixed to the top surface 294 of the dispenser platform 204 proximate a rear end 296. The top surface 294 of the dispenser platform 204 may include at least one longitudinally disposed recess suitably sized to receive a mounting portion 259 of the cleat 205, such that the top surface 361 of the mounting portion 259 is in a coplanar relationship with the top surface 294 of the dispenser platform 204. In such configuration, the lower edge 257 of the heel 245 may be level with the remaining portion of the lower edge 247 of the side walls 246, 248 of the frame 240.

To install the dispenser 202 on the dispenser platform 204, the rear end 262 of the frame 240 is positioned behind the cleat 205 so that a lip 298 is proximate the front portion 249 of the heel 245 in front of the channel 253. The dispenser 202 is moved toward the front end 255 of the dispenser platform 204 so that the lip 298 contacts the interior of the channel 253. Once engaged, the lip 298 may provide a structural restraint to prevent the rear end 262 of the frame 240 from lifting off of the top surface 249 of the dispenser platform 204 when the front end 258 of the frame 240 is acted upon by a forward or downward force, such as when loading the container 203 onto the upper support deck 250 or when removing product 206 from the first product display area 268 or the second product display area 280.

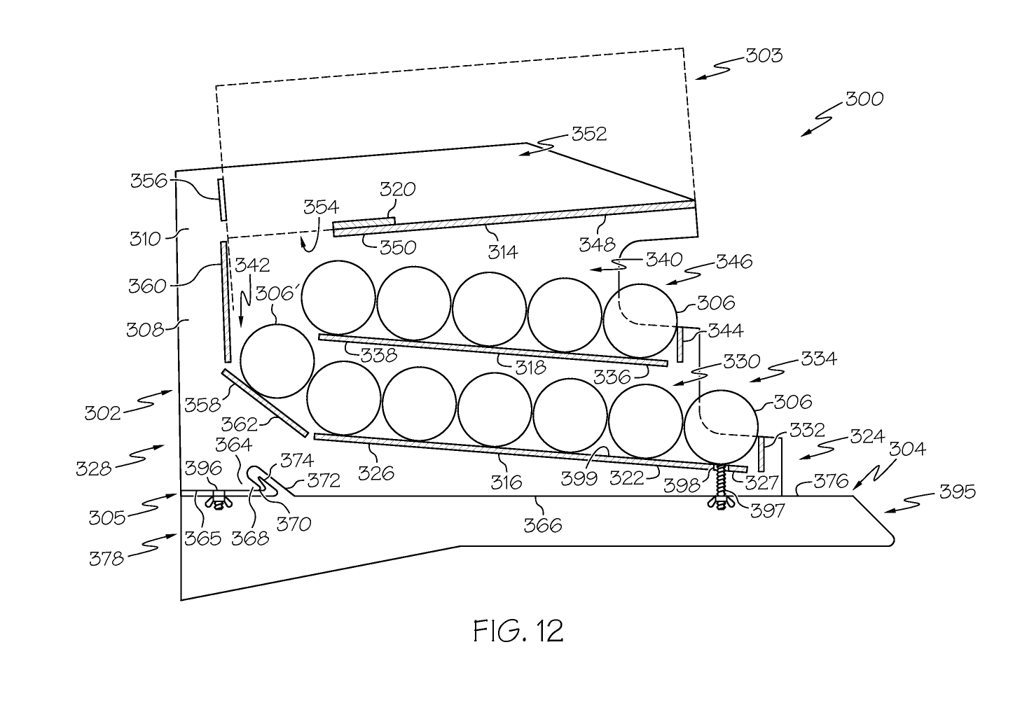

Referring next to FIG. 12, another aspect of the disclosed product dispenser system with dispenser platform, generally designated 300, may include a dispenser 302, a dispenser platform 304, and a cleat 305. The container 303 may initially house multiple units of product 306 and may be opened to release the products 306 into the dispenser 302 when the container 303 is loaded onto the dispenser 302. The dispenser platform 304 may include any generally horizontal surface such as a table top, a counter top, or shelf. The cleat 305 may be disposed upon the dispenser platform 304 and engage the dispenser 302 to prevent a rear end of the dispenser 302 from lifting off of the dispenser platform 304 when a front end of the dispenser 302 is acted upon by a forward or downward direction.

The container 303 may be of have six walls and be of any configuration as described herein above. For example, the container may include a removable opening feature defined by a plurality of weakened severance lines which may be removed from the container 303 to form an opening to access an internal volume of the container 303 such that products 306 may exit the container through the opening. Alternatively, for example, the container 303 may include an access panel defined by severance lines and that is openable about a pre-formed pivot line to form an opening to access an internal volume of the container 303 such that products 306 may exit the container 306 through the opening.

The dispenser 302 may include a frame 308 that supports the container 303 in a desired configuration (FIG. 12). The frame 308 may include a first (e.g., right) side wall 310, a second (e.g., left) side wall 312, an upper support deck 314, a lower support deck 316 and one or more intermediate support decks 318 (only one intermediate support deck 318 is shown by example in FIG. 12). The right side wall 310 may be laterally spaced from the left side wall 312, and may be generally parallel with the left side wall 312. The dispenser 302 may include one or more opening tools 320. The opening tools 320 may sever first and second severance lines of the container 303 to release the access door and form the opening in the container 303 as the container 303 is loaded onto the frame 308, thereby releasing the products 306 from the container 303 to the dispenser 302.

The lower support deck 316 may laterally extend between the right side wall 310 and the left side wall 312 of the frame 308 and may include a front end 322 that longitudinally extends toward the front end 324 of the frame 308 and a rear end 326 that longitudinally extends toward the rear end 328 of the frame 308. Therefore, the lower support deck 316 and the side walls 310, 312 may define a lower level 330 of the frame 308.

The lower support deck 316 may be inclined from the front end 322 to the rear end 326 (i.e., the rear end 326 may be elevated relative to the front end 322) such that products 306 deposited proximate the rear end 326 of the lower support deck 316 roll down to the front end 322 of the lower support deck 316 under the force of gravity. The extent of the incline of the lower support deck 316 may be dictated by, among other things, the coefficient of friction of the material used to form the frame 308 and the shape of the products 306 to be dispensed by the dispenser 302.

A lower stop 332 may be positioned proximate the front end 322 of the lower support deck 316 to prevent products 306 from rolling beyond the front end 322 of the lower support deck 316. Therefore, the stop 332 may collect products 306 at the front end 322 of the lower support deck 316, thereby defining a first product display area 334 proximate the front end 322 of the lower support deck 316.

The intermediate support deck 318 may be positioned between the upper support deck 314 and the lower support deck 316. The intermediate support deck 318 may laterally extend between the right side wall 310 and the left side wall 312 of the frame 308 and may include a front end 336 that longitudinally extends toward the front end 324 of the frame 308 and a rear end 338 that longitudinally extends toward, but not to, the rear end 328 of the frame 308. Therefore, the intermediate support deck 318 and the side walls 310, 312 may define an intermediate level 340 of the frame 308.

The spacing between the rear end 338 of the intermediate support deck 318 and the rear end 328 of the frame 308 may define an intermediate opening 342, which may function as a chute to allow products 306 to move from the intermediate level 340 down to the lower level 330 of the frame 308 under the force of gravity.

The intermediate support deck 318 may be inclined from the front end 336 to the rear end 338 (i.e., the rear end 338 may be elevated relative to the front end 336) such that products 306 deposited proximate the rear end 338 of the intermediate support deck 318 roll down to the front end 336 of the intermediate support deck 318 under the force of gravity. The extent of the incline of the intermediate support deck 318 may be dictated by, among other things, the coefficient of friction of the material used to form the frame 308 and the shape of the products 306 to be dispensed by the dispenser 302.

An intermediate stop 344 may be positioned proximate the front end 336 of the intermediate support deck 318 to prevent products 306 from rolling beyond the front end 336 of the intermediate support deck 318. Therefore, the stop 344 may collect products 306 at the front end 336 of the intermediate support deck 318, thereby defining a second product display area 346 proximate the front end 336 of the intermediate support deck 344. The second product display area 346 may be longitudinally displaced (e.g., inwardly) relative to the first product display area 334. The second product display area 346 may also be vertically displaced (e.g., upwardly) relative to the first product display area 334.

The upper support deck 314 may laterally extend between the right side wall 310 and the left side wall 312 of the frame 308 and may include a front end 348 that longitudinally extends toward the front end 324 of the frame 308 and a rear end 350 that longitudinally extends toward, but not to, the rear end 328 of the frame 308. Therefore, the upper support deck 314 and the side walls 310, 312 may define an upper level 352 of the frame 308.

The spacing between the rear end 350 of the upper support deck 314 and the rear end 328 of the frame 308 may define an upper opening 354, which may function as a chute to allow products 306 to move from the upper level 352 down to the intermediate 340 and lower 330 levels of the frame 308 under the force of gravity.

The upper support deck 314 may be declined from the front end 348 to the rear end 350 (i.e., the front end 348 may be elevated relative to the rear end 350). Therefore, products 306 supported on the upper support deck 314 may roll under the force of gravity down to the rear end 350 of the upper support deck 314, through the opening 354, to the lower and intermediate levels 330, 340 of the frame 308 and, ultimately, to the first product display area 334 and the second product display area 346.

Optionally, a container stop 356 may be disposed proximate the rear end 328 of the frame 308. The stop 356 may laterally extend between the side walls 310, 312 of the frame 308 proximate the upper level 352 of the frame 308 to inhibit rearward horizontal movement of the container 303 along the upper support deck 314 beyond the stop 356.

A guide 358 may be connected proximate the rear end 328 of the frame 308. The guide 358 may laterally extend between the right side wall 310 and the left side wall 312 of the frame 308 and may include a generally vertical upper end 360 that extends toward the upper support deck 314 and a declined lower end 362 that extends toward the rear end 326 of the lower support deck 316. The guide 358 may extend from proximate the upper opening 354 in the upper level 352 defined by the upper support deck 314, down through the intermediate opening 342 in the intermediate level 340 defined by the intermediate support deck 318 and, ultimately, down to the lower level 330 proximate the rear end 326 of the lower support deck 316.

Thus, the guide 358 may receive products 306 exiting through the opening in the container 303 and may guide the products 306 down proximate the rear end 326 of the lower support deck 316, thereby allowing the products 306 guided to the lower level 330 to ultimately move to the first product display area 334. Once the lower level 330 of the frame 308 has been filled with products 306 such that the opening 342 in the intermediate level 340 is bridged by a product 306′ (FIG. 12), the guide 358 may guide the products 306 down proximate the rear end 338 of the intermediate support deck 318, thereby allowing the products 306 guided to the intermediate level 340 to ultimately move to the second product display area 346.

The product dispensing system 300 may be assembled by opening the container 303 (e.g., tearing away the removable opening feature at the severance lines) and urging the opened container 303 along the upper support deck 314 of the frame 308 until the rear wall of the container 303 comes into abutting engagement with the stop 356. With the opened container 303 loaded onto the dispenser 302, the force of gravity may urge the products 306 housed in the container 303 through the opening in the container 303, down through the opening 354 in the upper level 352 of the frame 308 and, ultimately, to the first and second product display areas 334, 346.

Alternatively, the product dispensing system 300 may be assembled to dispense products 306 by positioning the container 303 onto the front end 348 of the upper support deck 314 of the frame 308 and urging the container 303 along the upper support deck 314 toward the stop 356. As the container moves relative to the opening tools 320, the opening tools 320 may sever the severance lines, thereby allowing the access panel to pivot relative to a base wall about the pre-formed pivot line. As the container 303 continues to move rearward, the access panel may drop through the opening 354 in the upper level 352 of the frame 308 to form the opening in the container 303, thereby allowing the products 306 in the container 303 to exit the container 303 through the opening under the force of gravity. As the products 306 exit the container 303, the guide 358 may guide the products 306 down through the opening 354 in the upper level 352 of the frame 308 and, ultimately, to the first and second product display areas 334, 346.

A heel 364 may be disposed at a lower longitudinal edge 366 of each side wall 310, 312 proximate the rear end 328 of the frame 308. The heel 364 may include a front portion 368 terminating in a tip 370 and formed with a channel 372 having an upwardly and rearwardly extending curved opening. Alternatively, the channel 372 may have an upwardly and rearwardly extending straight-edged opening. The channel 372 may be suitably sized and shaped to engage an upwardly and rearwardly extending lip 374 of the cleat 305. A lower longitudinal edge 365 of the heel 364 may be vertically displaced relative to the lower edge 366 of the remaining portion of the side walls 310, 312 of the frame 308, such that the dispenser frame 308 sits at a level when mounted atop the dispenser platform 304. The vertical displacement may be substantially equivalent to the thickness of the cleat 305 which protrudes above the top surface 376 of the dispenser platform 304.

The dispenser platform 304 may be a self-standing structure or may be a one of a plurality of support platforms. The dispenser platform 304 may be, for example, a shelf such as those used in retail shelving assemblies or other commercial shelving assemblies to hold and display merchandise. The dispenser platform 304 may include a generally flat top surface 376 to support at least one dispenser 302. In use, a plurality of dispensers 302 may be positioned in a side-by-side configuration upon the dispenser platform 304. The cleat 305 may be attached, fastened, mounted, or otherwise connected or affixed to the top surface 376 of the dispenser platform 304 proximate a rear end 378. The top surface 376 of the dispenser platform 304 may include at least one longitudinally disposed recess suitably sized to receive a mounting portion 380 of the cleat 305, such that the top surface 382 of the mounting portion 380 is in a coplanar relationship with the top surface 376 of the dispenser platform 304. In such configuration, the lower edge 365 of the heel 364 may be level with the remaining portion of the lower edge 366 of the side walls 310, 312 of the frame 308.

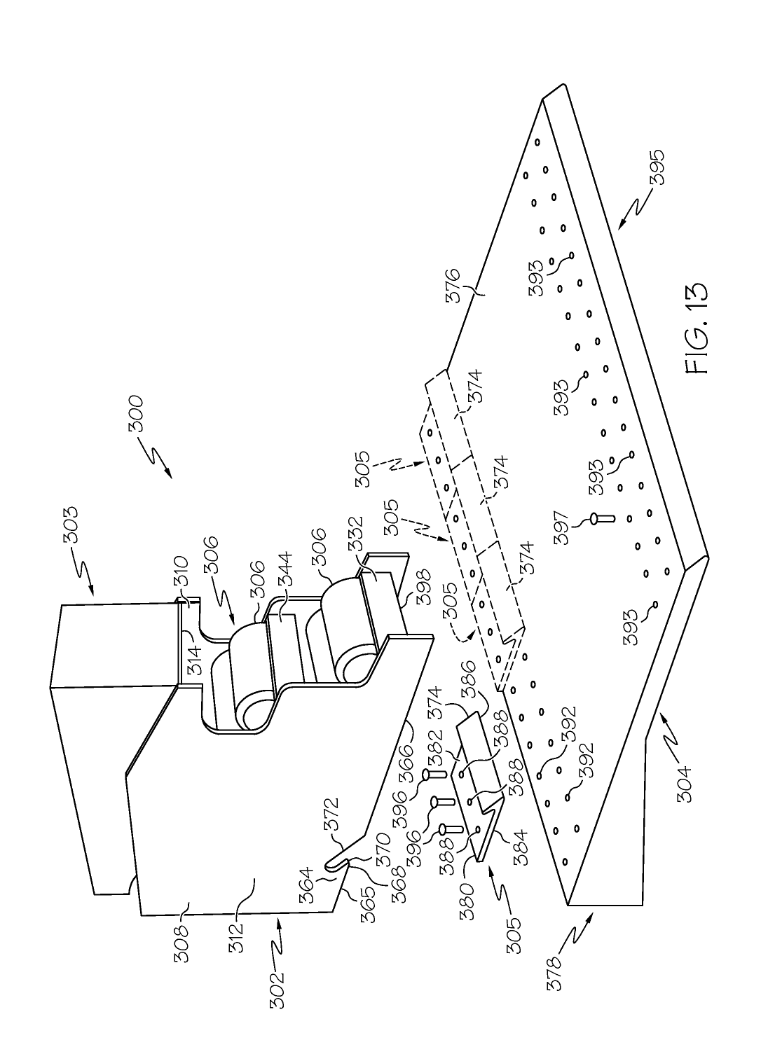

Referring to FIG. 13, the cleat 305 may include a mounting portion 380 which may have a continuous and planar top surface 382 and bottom surface 384. A front end 386 of the mounting portion 380 may have an upwardly and rearwardly extending, generally hook-shaped, curved lip 374 suitable for engaging against the interior of the channel 372 of the heel 364 of the dispenser frame 308. Alternatively, the lip 374 may be straight having a horizontal ledge suitable for engaging against the interior of the channel 372. Alternatively, the lip 374 may include a plurality of straight or curved, small, spaced-apart lips arranged along the longitudinal front end 386 of the mounting portion 380 for engaging against the interior of the channel 372.

The mounting portion 380 may include a plurality of spaced apart mounting apertures 388 extending longitudinally proximate a rear end 390 of the mounting portion 380. The dispenser platform 304 may include at least one row of a plurality of platform apertures 392 extending longitudinally proximate a rear end 378 of the dispenser platform 304. The cleat 305 may be fastened to the to a top surface 376 of the dispenser platform 304 proximate the rear end 378 such that the front end 386 of the mounting portion 380 is away from the rear end 378 of the dispenser platform 304 and the lip 374 extends toward the rear end 378 of the dispenser platform 304, generally parallel to a leading longitudinal edge of the dispenser platform 304. For example, the mounting portion 380 may be fastened to the top surface 376 of the dispenser platform 304 by aligning the apertures 388 of the mounting portion 380 with subjacent apertures 392 of the dispenser platform 304 and securing the mounting portion 380 to the dispenser platform 304 with a plurality of suitable mechanical fasteners 396, such as screws, nuts and bolts, or the like. The apertures 388 of the mounting portion 380 may be counter sunk holes having a diameter and chamfer angle suitable to receive a head of the fastener 396 in a coplanar relationship with a top surface 382 of the mounting portion 380.

In one implementation of the disclosed dispensing system 300, a plurality of cleats 305 may be fastened to the top surface 376 of the dispenser platform 304. As illustrated in FIG. 13, a single cleat 305 is shown in solid lines and additional cleats 305 are shown in broken lines. The cleat 305 may have a lateral width at least equivalent to a lateral width of the dispenser frame 308 measured from an exterior of the right side wall 310 to the exterior of the left side wall 312. It can be appreciated by one skilled in the art that the total number of cleats 305 mounted to the dispenser platform 304 may vary depending at least upon the dimensions of the dispenser platform 304 and the dimensions of the dispenser frame 308. Alternatively, the cleat 305 may have a lateral width sufficient to span two or more dispensers 302 configured in a side-by-side orientation, such that the lip 374 may engage the channels 372 of each dispenser frame 308. It can be appreciated by one skilled in the art that the lateral width of the cleat 305 may be limited only by the lateral width of a given dispenser platform 304.

The lower support deck 316 may include at least one deck aperture 398 proximate the front end 322. The front end 322 of the lower support deck 316 may terminate in a generally flat section 327, such that the flat section 327 of the lower support deck 316 is parallel to the top surface 376 of the dispenser platform 304 when the dispenser 302 is positioned atop the dispenser platform 304. The dispenser platform 304 may include at least one row of a second plurality of platform apertures 393 proximate the front end 395. The dispenser 302 may be fastened to the dispenser platform 304 proximate the front end 395. For example, frame 308 may be fastened to the top surface 376 of the dispenser platform 304 by aligning the apertures 398 of the lower support deck 316 with subjacent apertures 393 of the dispenser platform 304 and securing the frame 308 to the dispenser platform 304 with at least one suitable mechanical fastener 397, such as screws, nuts and bolts, or the like. The aperture 398 of the lower support deck 316 may be a counter sunk hole having a diameter and chamfer angle suitable to receive a head of the fastener 397 in a coplanar relationship with a top surface 399 of the lower support deck 316.

To install the dispenser 302 on the dispenser platform 304, the rear end 328 of the frame 308 is positioned behind the cleat 305 such that the lip 374 is proximate the front portion 368 of the heel 364 in front of the channel 372. The dispenser 302 is moved toward the front end 395 of the dispenser platform 304 so that the lip 374 contacts the interior of the channel 372. Once engaged, the lip 374 may provide a structural restraint to prevent the rear end 328 of the frame 308 from lifting off of the top surface 376 of the dispenser platform 304 when the front end 324 of the frame 308 is acted upon by a forward or downward force, such as when loading the container 303 onto the upper support deck 314 or when removing product 306 from the first product display area 334 or the second product display area 346.

Accordingly, the disclosed product dispensing systems may employ multiple support decks with multiple product display areas, thereby increasing the amount of product being displayed to potential consumers and increasing the amount of product that may be supported by a given dispenser. Furthermore, the disclosed product dispensing systems may improve stocking efficiency by optionally employing an opening tool configured to automatically open a container as the container is loaded onto the dispenser. Furthermore, the disclosed product dispensing systems may include a dispenser platform to support at least one dispenser when displaying and dispensing the product. The disclosed product dispensing systems may also include a retaining cleat to secure at least one dispenser to the dispenser platform to prevent inadvertent or accidental tipping or movement of the dispenser from the dispenser platform.

Although various aspects of the disclosed product dispensing system with dispenser platform have been shown and described, modifications may occur to those skilled in the art upon reading the specification. The present application includes such modifications and is limited only by the scope of the claims.

What is claimed is:

1. A product dispensing system comprising:
a dispenser frame having a front end, a rear end, and a lower edge extending between said front end and said rear end of said dispenser frame, said dispenser frame comprising:
an upper support deck extending between said front end and said rear end of said dispenser frame;
a lower support deck positioned below said upper support deck, said lower support deck extending between said front end and said rear end of said dispenser frame and defining a product display area; and
a heel positioned proximate said rear end of said dispenser frame, said heel comprising a channel, said channel extending upwardly and rearwardly from said lower edge toward said rear end of said dispenser frame; and
a cleat, wherein at least a portion of said cleat extends into said channel when said heel engages said cleat.

2. The product dispensing system of claim 1 wherein said dispenser frame further comprises first and second laterally opposed side walls, and wherein said heel is defined by said side walls.

3. (canceled)

4. The product dispensing system of claim 1 further comprising a dispenser platform comprising a front end, a rear end and a top surface configured to support said dispenser frame, said top surface extending between said front end and said rear end of said dispenser platform; wherein said cleat is connected to said dispenser platform proximate said rear end of said dispenser platform, at least a portion of said cleat protruding toward said rear end of said dispenser platform.

5. The product dispensing system of claim 4 wherein said cleat comprises a mounting portion configured to be connected to said top surface of said dispenser platform and a lip extending upwardly and rearwardly from said top surface toward said rear end of said dispenser frame, and wherein at least a portion of said lip extends into said channel when said heel engages said cleat.

6-8. (canceled)

9. The product dispensing system of claim 1 wherein said cleat comprises an upwardly and rearwardly extending lip; and wherein said lip extends toward said rear end of said dispenser frame when said heel engages said cleat.

10. The product dispensing system of claim 1 further comprising:
a container on said upper support deck; and
a plurality of products initially housed in said container.

11. The product dispensing system of claim 10 further comprising an opening tool positioned to open said container and allow at least one product of said plurality of products to move from said container to said product display area as said container is moved along said upper support deck from said front end toward said rear end.

12. A product dispensing system comprising:
a container initially housing a plurality of products;
a frame having longitudinally opposed front and rear ends and a lower edge extending between said front and rear ends of said dispenser frame, said frame comprising:
an upper support deck extending at least partially between said front end and said rear end of said frame;
a lower support deck positioned below said upper support deck, said lower support deck defining a product display area;
a heel positioned proximate said rear end of said frame, said heel comprising a channel formed in said frame, said channel extending upwardly and rearwardly from said lower edge toward said rear end of said frame; and
an opening tool associated with said frame and arranged to open said container when said container is moved longitudinally along said upper support deck and allow said plurality of products to be at least partially dispensed from said container to said product display area;
a dispenser platform comprising a front end, a rear end, and a substantially planar top surface configured to support said frame, said top surface extending between said front end and said rear end of said dispenser platform; and
a cleat connected to said top surface proximate said rear end of said dispenser platform and proximate said rear end of said dispenser frame, said cleat protruding upwardly and rearwardly from said top surface toward said rear end of said dispenser platform,
wherein at least a portion of said cleat is received in said channel when said heel engages said cleat.

13. The product dispensing system of claim 12 wherein said dispenser frame further comprises first and second laterally opposed side walls, and wherein said heel is defined by said side walls.

14. The product dispensing system of claim 12 wherein said product display area is proximate said front end.

15. The product dispensing system of claim 12 wherein said dispenser frame includes first and second laterally opposed side walls, each side wall having a lower longitudinal edge defining said lower edge of said frame.

16. The product dispensing system of claim 15 wherein said channel extends upwardly and rearwardly from said lower longitudinal edge of said first and second side walls.

17. (canceled)

18. The product dispensing system of claim 12 wherein said cleat comprises an upwardly and rearwardly extending lip, and wherein at least a portion of said lip extends into said channel.

19. A method for dispensing a plurality of product initially provided in a container, said method comprising the steps of:
providing a dispenser comprising:
a frame having a front end and a rear end, a lower edge extending between said front end and said rear end, an upper support deck extending at least partially between said front end and said rear end, a lower support deck positioned below said upper support deck, said lower support deck defining a product display area, and a heel positioned proximate said rear end, said heel comprising a channel formed in said frame, said channel extending upwardly and rearwardly from said lower edge toward said rear end of said frame;
providing a dispenser platform comprising a front end, a rear end, and a substantially flat top surface configured to support said dispenser frame; and,
providing a cleat connected to said top surface proximate said rear end of said dispenser platform and proximate said rear end of said dispenser frame, said cleat protruding upwardly and rearwardly from said top surface toward said rear end of said dispenser platform;
positioning said frame upon said dispenser platform such that at least a portion of said cleat is received in said channel; and
positioning said container on said upper support deck.

20. The method of claim 19 wherein said container is automatically opened during said positioning said container step.

21. The product dispensing system of claim 9 wherein said lip comprises a profile shape substantially matching a shape of said channel; and wherein at least a portion of said lip is received in said channel when said heel engages said cleat.
